(19) United States
(12) Patent Application Publication
(10) Pub. No.: US 2010/0047606 A1
(43) Pub. Date: Feb. 25, 2010

(54) FRICTION WELDING METHOD AND FRICTION WELDING PART

(75) Inventor: Karl Seidinger, Volkertshausen (DE)

Correspondence Address: BACHMAN & LAPOINTE, P.C., 900 CHAPEL STREET, SUITE 1201, NEW HAVEN, CT, 06510, US

(73) Assignee: GEORG FISCHER ENGINEERING AG, Schaffhausen (CH)

(21) Appl. No.: 12/514,691

(22) PCT Filed: Jan. 8, 2008
(86) PCT No.: PCT/EP2008/050137

§ 371 Date: May 13, 2009

(30) Foreign Application Priority Data
Jan. 17, 2007 (EP) 07100637.3

(51) Int. Cl. B32B 1/08; B23K 20/12; B32B 15/01

(52) U.S. Cl. 428/586; 228/114.5; 428/615

(57) ABSTRACT

The invention relates to a friction welding method for the production of a metal bonded joint, wherein two connection parts having contact surfaces are brought into contact with friction pressure. One of the connection parts is moved with respect to the other connection part and, after a time period of friction, the movement is stopped. During a time period of compression, the connection parts are pressed against each other with a compression pressure which is greater than the friction pressure. At least one of the connection parts is constructed of cast iron with nodular graphite (=GJS).

### BACKGROUND OF THE INVENTION

The invention relates to a friction welding method for producing a friction welding part, wherein two connection parts with contact surfaces are brought into contact by means of friction pressure, wherein one of the connection parts is moved relative to the other connection part, wherein the relative movement is decelerated after a friction time, wherein the connection parts are pressed against one another by means of a forging pressure which is higher than the friction pressure, and wherein at least one of the connection parts is formed from spheroidal graphite cast iron (GJS).

In motor vehicle construction, rotationally symmetrical parts, i.e. tubular or cylindrical parts, for example shafts, axle journals or other drive parts, are joined together by means of friction welding. In this process, the parts to be joined together are pressed toward one another and brought into a relative movement with respect to one another. The material becomes plastic to molten due to the heat of friction thereby produced process. During the friction welding of spheroidal graphite cast iron, the metal structure can be changed in the connection region. Firstly, the graphite bodies act as a lubricant and therefore produce insufficient heat of friction; secondly, the structure is changed in the connection region such that the mechanical properties of the parts which have been joined together are changed.

EP 273204 B1 discloses a friction welding method of the type in question. In this method, friction welding is used to connect a steel component to a further component of spheroidal graphite cast iron. The cast iron used has a ferritic structure comprising 280 to 300 ferrite grains per mm². The aim of this connection method is to prevent excessive carbon from the cast iron diffusing into the steel in the connection region and, firstly, to prevent the melt from being pressed out of the forging region with an increased carbon content but, secondly, to prevent the spheroidal graphite bodies in the cast iron from being flattened into flakes. This is achieved by setting the friction time at approximately 40 seconds, by setting the forging pressure at approximately 86 bar and by pre-treating the cast iron in a magnesium converter.

On the basis of this prior art, the object of the invention is to specify a friction welding method which can be used as reproducibly and cost-effectively as possible in series production. The object of the invention is also to specify a friction welding part in the case of which the tensile strength values in the connection region are increased. Changes in the structure resulting in poorer quality should be avoided. It should be possible to dispense with time-consuming heat treatment for establishing a better structure in the case of cast iron/cast iron connections.

### SUMMARY OF THE INVENTION

This object is achieved by means of a friction welding method for producing a joined metal part, wherein two connection parts with contact surfaces are brought into contact by means of friction pressure, wherein one of the connection parts is moved relative to the other connection part, wherein the relative movement is decelerated after a friction time, and wherein, during a forging time, the connection parts are pressed against one another by means of a forging pressure which is higher than the friction pressure, wherein at least one of the connection parts is formed from spheroidal graphite cast iron (GJS), wherein at most 20% of the spherulites in the spheroidal graphite cast iron are deformed in the connection region, and wherein 30 to 90% of the structure in the spheroidal graphite cast iron is pearlitic.

### BRIEF DESCRIPTION OF THE DRAWINGS

FIG. 1 is a graph showing the relationship between elongation and fraction of deformed graphite particles; and

FIG. 2 is a schematic illustration of the weld region.

### DETAILED DESCRIPTION

It is advantageous that it is also possible to join together cast-iron alloys with a near-eutectic composition. This is achieved by at least one of the connection parts being formed from spheroidal graphite cast iron with a composition which comprises 3.0 to 3.9% by weight C and 2.0 to 3.2% by weight Si, with the structure being 30 to 90% pearlitic. This is also achieved by both connection parts being formed from spheroidal graphite cast iron (GJS).

### EXAMPLES

Two tubular test pieces with an external diameter of 70 to 71 mm and a wall thickness of 10 to 11 mm are connected to one another using a known friction welding system and their strength is then tested. The friction time is 10 to 20 seconds, the friction pressure is 25 to 45 MPa, and the forging pressure is 100 to 220 MPa, depending on the material pairing used. After the friction welding operation, the connection is shortened by 3 to 6 mm. The shortening increases with the friction time. The tensile strength in the connection region is equal to or more than the tensile strength of the test pieces used. If two test pieces with differing compositions and differing strengths are welded together, the tensile strength in the connection region after welding is equal to or more than the tensile strength of the weaker test piece. In the case of all connections, the breaking point is not in the welded connection itself, but rather in the base material. The following were used as base material: S355 (St52), S420, GJS500, GJS600, SiboDur 450 and/or SiboDur 700. Here, the numbers given represent the tensile strength of the base material in MPa. In this case, SiboDur represents a spheroidal graphite cast-iron alloy with a composition which comprises 3.0 to 3.6% by weight C and 2.6 to 3.2% by weight Si, and with a 30 to 90% pearlitic structure. The connection is deemed to be in order in terms of welding technology.

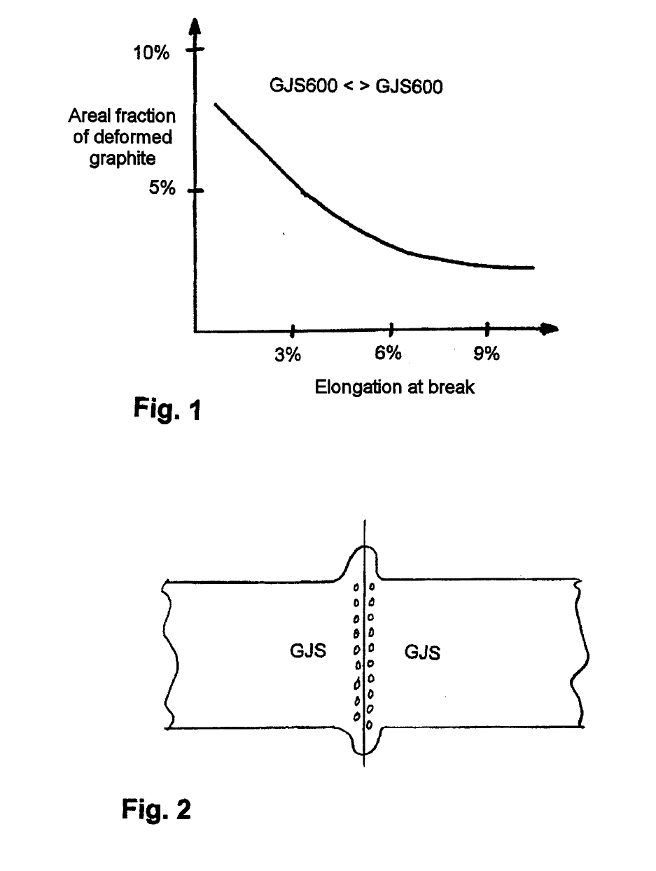

It is apparent from FIG. 1 that optimum values for elongation at break can be achieved depending on the degree of deformation of the spherulites. During friction welding, the spheroidal graphite particles in the cast iron (spherulites) are deformed to give ellipsoids or are flattened at least in certain regions. The degree of deformation is measured as a percentage of the deformed graphite particles at the cut surface investigated. Friction welding parts produced by the present method are observed to achieve optimum strength values when at most 20% of the spherulites are deformed.

FIG. 2 schematically shows a friction welding part formed from two connection parts composed of GJS with deformed and non-deformed spheroidal graphite particles. The spheroidal graphite particles in the connection region are deformed by at most 20%, preferably at most 10%, i.e. the shape deviates from the spheroidal shape by at most 20%. The more the spheroidal graphite particles in the connection region are deformed to form flakes, the poorer the strength values in the connection region become.

The experiments show that high-strength friction welded connections can be achieved with test pieces formed from spheroidal graphite cast-iron alloys. The welding times are far less than 30 seconds. The welded connection itself only reaches molten metal flow and can be established in a virtually spatter-free manner. In the region of the connection seam, the structure in the load-bearing cross section is not adversely changed.

The friction welding method can be used in vehicle and machine construction for joined metal parts such as, for example, axles, shafts or pipes or other drive parts, for example a wheel hub or axle journal. Crossmembers or other parts in tool manufacture can also be produced by means of the friction welding method.

1-10. (canceled)

11. A friction welding method for producing a joined metal part, wherein two connection parts with contact surfaces are brought into contact by means of friction pressure, wherein one of the connection parts is moved relative to the other connection part, wherein the relative movement is decelerated after a friction time, wherein, during a forging time, the connection parts are pressed against one another by means of a forging pressure which is higher than the friction pressure, and wherein at least one of the connection parts is formed from spheroidal graphite cast iron (GJS), wherein at most 20% of the spherulites in the spheroidal graphite cast iron are deformed in the connection region, and in that 30 to 90% of the structure in the spheroidal graphite cast iron is pearlitic.

12. The friction welding method as claimed in claim 11, wherein at least one of the connection parts is formed from spheroidal graphite cast iron with a near-eutectic composition, which comprises 3.0 to 3.6% by weight C and 2.6 to 3.2% by weight Si, and with a 30 to 90% pearlitic structure.

13. The friction welding method as claimed in claim 11, wherein at least one of the connection parts is formed from steel with a minimum yield strength of 355 MPa.

14. The friction welding method as claimed in claim 1, wherein both connection parts are formed from spheroidal graphite cast iron (GJS).

15. The friction welding method as claimed in claim 11, wherein inductive heating is used to keep the temperature of the joined metal part above 750° C. during and after the forging time.

16. The friction welding method as claimed in claim 11, wherein the temperature of the joined metal part is kept above 750° C. for a total of approximately 12 to 120 seconds during and after the forging time.

17. The friction welding method as claimed in claim 11, wherein the relative movement of the connection parts is a rotary movement.

18. The friction welding method as claimed in claim 11, wherein at least the contact surfaces of the connection parts have a rotationally symmetrical form.

19. A friction welding part as claimed in claim 11, wherein the joined metal part is embodied as a pipe, axle, shaft, wheel hub or axle journal.

20. The friction welding part as claimed in claim 19, wherein the joined metal part is embodied as a component in vehicle construction, tool manufacture or machine construction.
